(19) United States
(12) Patent Application Publication
(10) Pub. No.: US 2007/0055489 A1
(43) Pub. Date: Mar. 8, 2007

(54) Method and system for supplying an automatic web content translation service

(76) Inventors: Etienne Annic, Rambouillet (FR); Anne Boutroux, Hermanville Sur Mer (FR); Jean-Francois Ravier, St. Arnoult (FR)

Correspondence Address: FISH & RICHARDSON P.C., P.O. BOX 1022, MINNEAPOLIS, MN, 55440-1022, US

(21) Appl. No.: 10/543,354

(22) PCT Filed: Jan. 7, 2004
(86) PCT No.: PCT/FR04/00020

§ 371 Date: Oct. 17, 2006

(30) Foreign Application Priority Data
Jan. 28, 2003 (FR) 03/00915

(51) Int. Cl. G06F 17/28

(52) U.S. Cl. 704/2

(57) ABSTRACT

The invention relates to a method and system for supplying an automatic web content translation service. More specifically, the invention relates to a method of supplying translations of documents which are distributed by content providers (4) to numerous user terminals (11, 12, 13) by means of a data transmission network (1). The inventive method consists in: inserting information into at least one document which is distributed by content providers (4), said information defining the subject of the document and being delimited within said document by pre-defined subject boundary tags; when a distributed document is transmitted to a user terminal (11, 12, 13), intercepting the distributed document, extracting the information relating to subject from said document, and translating the structured document, taking account of the subject information; inserting the translation obtained into a document resulting from the translation; and transmitting the document resulting from the translation to the user terminal, by replacing the intercepted document, so that it can be displayed on the screen of the terminal by the net browser.

The invention relates to the extra services that an Internet service provider can provide.

It notably applies, but not exclusively, to service providers providing Internet access and who wish to extent their access packages by proposing extra services to their clients.

The internet network being a global network, it provides access to Web pages which can be in any given language. To expand their audience, some Web sites display Web pages in several languages at the user's discretion. However, these sites are few and far between. Furthermore, the running costs of multilanguage sites are high, because every time a Web page is modified or added, the modifications have to be translated and inserted into the other language pages. In this context, it is appropriate to offer the users an automatic translation service, and all the more so as the quality level of the translations is high.

Currently, there are several standards of quality for automatic Web content translations. The simple quality, known as “basic”, automatic translation systems solely use a standard dictionary. The translation of ambivalent words is there done in an arbitrary manner. As a result, the translations provided by such systems can prove to be incomprehensible and littered with misunderstandings.

Some systems producing better quality translations not only use such standard dictionaries but also thesauruses or subject dictionaries allowing to resolve some ambiguities in relation to the topic of the document to be translated. These systems require the prior choice of one or several of subject dictionaries. The quality of the translations these systems provide therefore depends on the availability of subject dictionaries corresponding to the document to be translated and on the pertinence of the choice of dictionaries to be used for the translation, according to the subject of the document to be translated.

The systems that provide the best standard of quality integrate the notion of subject matter and type. The notion of subject matter defines the context in which the text is to be translated (for example, finance, culinary, sport). The notion of type defines the literary family to which the text to be translation belongs (for example, letters, recipes, script).

Among this type of system, we know for example the TAUM system (Automatic translation of the University of Montreal) which is specialized in translating meteorological oriented letters.

These systems have the drawback of being specifically applicable to a specific subject and type of document. In order to translate a wide variety of documents of diverse nature a large number of specialized translation systems will be needed.

The purpose of the invention is to overcome these drawbacks. This object is achieved by providing a method of supplying translations of documents which are distributed by content providers to numerous user terminals by means of a digital data transmission network, the documents being structured by tags which are processed by a net browser executed by the user terminals.

According to the invention, this method comprises steps of:

a. inserting, into at least one document distributed by the content providers, information defining a subject of the document, this information being delimited in the document by pre-defined subject boundary tags;

b. when a distributed document is transmitted to a user terminal, intercepting the distributed document, extracting the information relating to the subject from the distributed document, translating the structured document taking into account the subject information, and inserting the translation obtained into a document resulting from the translation; and

c. transmitting the document resulting from the translation to the user terminal instead of the intercepted document so that it can be displayed on the screen of the terminal by the net browser.

Advantageously, the pre-defined subject boundary tags are chosen so as to be not interpreted by the net browser, so that when the distributed document is displayed on the screen of the user terminal, the subject information is not displayed.

According to an embodiment of the invention, the subject information inserted into a document distributed by the content providers is associated with type information in the document, delimited in the document by pre-defined type boundary tags, chosen so as to be not interpreted by the net browser, so that when the distributed document is displayed on the screen of the user terminal, the type information is not displayed, the translating of the document being performed taking account of the type information.

According to an embodiment of the invention, a structured document resulting from the translation is transmitted to the user terminal instead of the intercepted document, solely upon prior user request.

Preferably, an intercepted document is transmitted from the network to a user terminal following a request made by the latter to the network, a document resulting from the translation corresponding to the intercepted document being transmitted to the user terminal solely if the request for the intercepted document comprises a translation request indicator.

According to an embodiment of the invention, the user terminal accesses the network by means of a service provider which performs the steps (b) and (c) when it receives a document from the network containing subject information directed to a user terminal connected to the service provider.

According to another embodiment of the invention, this method comprises a step of configuring, by the user to the service provider, a parameter indicating if he wishes or not to obtain a translation instead of the documents that were sent to him by the network, a document resulting from the translation being transmitted to the user terminal instead of the document transmitted by the network, as long as the parameter indicates that the user wishes to obtain a translation of the documents transmitted by the network.

According to another embodiment of the invention, a target language into which the documents are to be translated is pre-defined.

Alternatively, this method comprises a step of selecting, by the user, a target language into which the documents are to be translated.

According to an embodiment of the invention, this method comprises a step of switching the intercepted document to a specialized translating machine, according to the extracted subject and/or type of the intercepted document.

Advantageously, if the extracted subject and/or type of the intercepted document does not correspond to an available specialized translating machine, or if no subject and/or type information is in the intercepted document, the intercepted document is switched to a standard translating machine.

The invention also relates to a system for supplying translations of documents distributed by the content providers to a plurality of user terminals by means of a digital data transmission network, the documents being structured by the tags which are processed by a net browser executed on the user terminals.

According to the invention, the distributed documents at least partly comprise subject information delimited by the pre-defined subject boundary tags, the system comprising:
means for intercepting the distributed documents transmitted by the network to a user terminal;
means for extracting the subject information in the intercepted documents;
means for translating an intercepted document taking account of the subject information extracted from the document, and means for inserting the translation obtained in a structured document resulting from the translation; and
means for transmitting the document resulting from the translation to the user terminal instead of the intercepted document, which is to be displayed on the screen of the terminal via the net browser.

Advantageously, the subject information inserted into a document distributed by the content providers is associated with type information of the document, delimited in the document by pre-defined type boundary tags, chosen so as to be not interpreted by the net browser, so that when it displays the distributed document on the screen of the user terminal, the type information is not displayed, the translating means taking account of the type information so as to translate.

According to an embodiment of the invention, this system is implemented by a service provider offering the user terminals access to the network.

According to an embodiment of the invention, this system is implemented using the ICAP protocol so as to intercept the documents supplied in reply to requests made by the user terminals, and so as to transmit the intercepted documents to a document translation service.

Advantageously, the translating means comprise specialized translation machines each adapted to a subject and/or type, a standard translation machine, means for switching each intercepted document to a translation machine adapted to the extracted subject and/or type of the intercepted document, or to a standard translation machine if the intercepted document does not comprise subject and/or type information or if the extracted subject and/or type of the intercepted document does not correspond to any of the specialized translation machines.

Alternatively, the translation server comprises a translation machine, the subject and type information used to select one or several dictionaries to be used by the translation machine to carry out the translation, and the type information used to select an operating mode of the translation machine or a specialized translation software.

A preferred embodiment of the invention will be described below, by way of non-restrictive example and in reference to the annexed drawings in which:

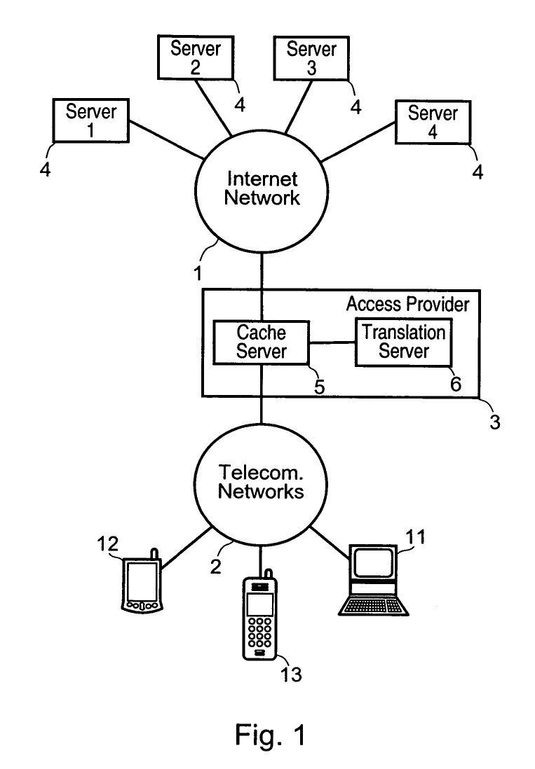

FIG. 1 diagrammatically represents a system according to the invention;

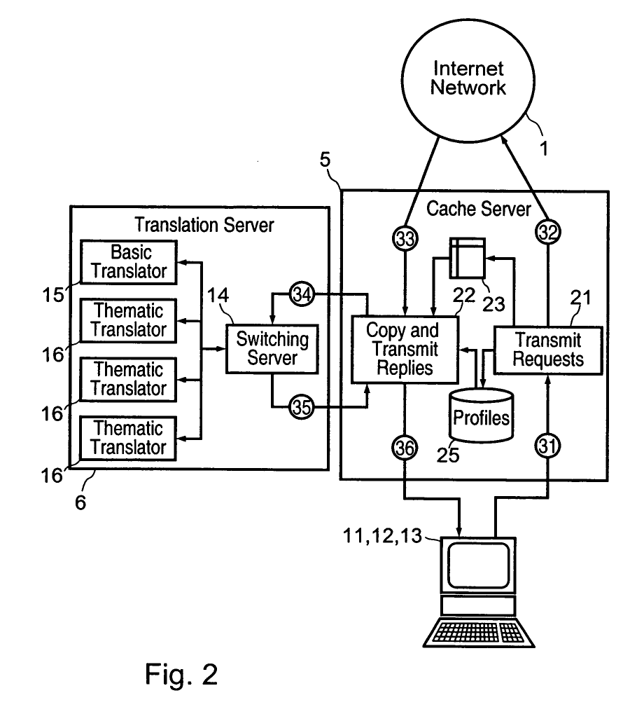

FIG. 2 shows in greater detail the system represented in FIG. 1.

The system represented in FIG. 1 comprises a service provider 3 allowing users equipped with a connection to the telecommunications network 2 to access a public data transmission network 1 such as the Internet network, this network being connected to servers 4 supplying different services such as distribution of information.

The users have a terminal 11, 12, 13 that can be connected to the network 2 so as to access the service provider 3. This terminal can be a personal computer 11, a communicative personal digital assistant (PDA) 12 or even a cellular telephone 13.

According to the invention, the service provider 3 comprises a cache server 5 or a Web proxy server (proxy/cache) laid out as a flow splitter, dedicated to supplying an automatic translation service, this server being connected to a translation server 6.

As shown in greater detail in FIG. 2, the proxy/cache server 5 comprises means for receiving 21 in the requesting step 31 Web pages emitted by the users, these requests complying for example with HTTP protocol (HyperText Transfer Protocol). Such requests notably comprise an identifier of the request emitting terminal, for example the IP address (Internet Protocol) of the emitter, and the IP address of the page to be accessed, distributed by a server 4.

Traditionally, the received HTTP requests are recorded in a table 23 and retransmitted in step 32 to the network 1 upon reception.

The server 5 further comprises means for receiving 22 in step 33 the Web pages transmitted in reply to the requests. The re-transmitting means 22 provide thus access to the table 23 in order to determine the address of the recipient of the received Web page according to the address of the latter. Thus having determined the recipient user of the Web page, the re-transmitting means 22 re-transmit it to the user in step 36.

According to the invention, the cache server 5 is additionally designed to manage the translation requests emitted by the users, in association with the requests for Web pages, in order to transmit the Web pages received by the translation server 6, and to transmit the translations supplied by the server 6 to the users.

Furthermore, according to the invention, the Web pages distributed by the servers 4, which are usually in the form of HTML files (HyperText Markup Language), comprise a specific tag, for example <subject> . . . </subject> delimiting subject information, and possibly a specific tag, for example <type> . . . </type> delimiting type information of the contents. This information which is inserted by the content provider or the site editor, allows to associate a subject and a type with a Web page.

It is to be noted that these specific tags are chosen so as to be not interpreted by the net browser used by the users to display the received Web pages. This means that the net browser does not display the information between these tags when displaying the Web page on the screen of the terminal.

Moreover, the translation server 6 comprises a switching server 14 coupled to subject translation machines 16 and possibly a standard translation machine 15. The switching server extracts and analyses the subject and the type associated with each Web page to be translated and sends the latter to the translation machine 16 corresponding to the subject and/or the type associated with the page. If the subject and/or type of the Web page to be translated does not correspond to any available subject translation machine 16 or if this information is not to be found on the Web page, the latter is sent to the standard translation machine 15.

Alternatively, the translation server 6 may only comprise of a single translation machine, the subject and type information being used to select one or several dictionaries to be used to carry out the translation and the type information being used to select an operating mode of the translation machine or a specific translation software.

In a first alternative of the invention, the user indicates that he wishes to obtain a translation of the Web page that he requests using a Web interface which allows him to enter translating mode.

Thus, each Web page transmitted by the service provider to the user can comprise for example a personalization streamer which is inserted on the fly by the service provider, for example by a ICAP service (Internet Content Adaptation Protocol). This streamer comprises for example a check box that the user can tick in order to select the translating mode, or remove the tick to enter normal mode.

The target language into which the documents are to be translated can be a pre-defined language, for example that of the country in which the service provider is established.

We can also plan on giving the user the opportunity to choose a target language by means of a selection field within the selection streamer in the translating mode.

A translation request indicator is recorded and updated in the table 23 or in another storing means 25, according to the state of this check box, in association with the user identifier, and possibly with a parameter defining the target language selected by the user.

The storing means 25 can comprise an access control list (ACL) which manages the user addresses for which the translating mode is activated.

The storing means 25 can be localized in the server 5 or be localized in and interrogated by the server 5, for example by means of the network 1.

When the re-transmitting means 22 receive a Web page associated in the table 23 with a translation request indicator from the network 1, they re-transmit the page to the translation server 6, in step 34. Upon receiving a Web page, the server 6 analyses it in order to detect the specific tags delimiting the subject and the type of the Web page content, translates the text in it taking account of the subject and type information delimited by the tags, and manages an HTML page presenting the translation of the text. The HTML translation page thus generated is transmitted in step 35 to the re-transmitting means 22, which re-transmit it to the user terminal in step 36.

It is to be noted that the generation of the HTML translation page can simply consist in replacing the text zones in the page to be translated by the translation of these zones.

In this way, the user obtains a translation of the requested Web pages, that is understandable and pertinent.

Furthermore, the association of a definition of a subject and of a type with a Web page is simple because all it requires is the implementation of a tag system.

Alternatively, the user can be given the opportunity of configuring, for example to the access provider 3, via a Web interface, a translating mode parameter indicating if he wishes or not to obtain a translation prior to transmission of the Web page transmitted by the Internet network, as well as possibly a parameter defining the target language in which the translations are to be done. These parameters are for example recorded in the storing means 25 in association with the user identifier (IP address). As long as the translating mode parameter indicates that the user wishes to obtain translations, the re-transmitting means 22 transmit translations to the user instead of all the pages from the Internet network, which are to be sent to it.

In this embodiment, the storing means 25 can also be localized in the server 5 or be moved and interrogated by the server 5, for example by means of the network 1.

Advantageously, the system which has just been described can be easily implemented by using the ICAP protocol. This protocol is specifically designed to intercept requests or HTTP replies transiting via a proxy server, and to transmit these requests or replies to a specific service which modifies them prior to re-transmitting them.

Of course, the translation supply service can be carried out without using the ICAP protocol. It can also be carried out by using the API (Application Programming Interface) of a proxy cache server.

1-17. (canceled)

18. A Method for supplying translations of documents which are distributed by content providers to numerous user terminals by means of a digital data transmission network, the documents being structured by tags which are processed by a net browser executed by the user terminals, said method comprising steps of:
a. inserting into a document distributed by the content provider, information defining a subject of the document, said information being delimited in the document by subject boundary tags;
b. when the distributed document is transmitted to a user terminal, intercepting the distributed document, extracting the information relating to the subject from the distributed document, translating the intercepted document taking into account the subject information, and inserting the translation obtained into a translation document; and
c. transmitting the translation document to the user terminal instead of the intercepted document so as to be displayed on a screen of the user terminal by a net browser.

19. The method of claim 18, wherein the subject boundary tags are chosen so as to be not interpreted by said net browser, so that the subject information is not displayed when the distributed document is displayed on the screen of the user terminal.

20. The method of claim 18, wherein the subject information inserted into a document distributed by the content provider is associated with type information in the document, delimited in the document by type boundary tags, chosen so as to be not interpreted by said net browser, so that the type information is not displayed when the distributed document is displayed on the screen of the user terminal, the translation of the document being performed taking account of the type information.

21. The method of claim 18, wherein the translation document is transmitted to the user terminal instead of the intercepted document, solely upon prior user request.

22. The method of claim 18, wherein the intercepted document is transmitted from the network to the user terminal following a request made by the user to the network, the translation document corresponding to the intercepted document being transmitted to the user terminal solely if a request for the intercepted document, emitted by the user terminal, comprises a translation request indicator.

23. The method of claim 18, wherein the user terminal accesses the network by means of a service provider which performs the steps (b) and (c) when it receives a document from the network containing subject information, directed to a user terminal connected to the service provider.

24. The method of claim 23, further comprising a step of configuring, from the user to the service provider, a parameter indicating if the user wishes or not to obtain a translation instead of the documents that were sent to him by the network, a translation document being transmitted to the user terminal instead of a document transmitted by the network, as long as the parameter indicates that the user wishes to obtain a translation of the documents transmitted by the network.

25. The method of claim 18, wherein a target language into which the documents are to be translated is pre-defined.

26. The method of claim 18, further comprising a step of selecting, by the user, a target language into which the intercepted documents are to be translated.

27. The method of claim 18, further comprising a step of switching the intercepted document to a specialized translation machine, according to the extracted subject and/or type of the intercepted document.

28. The method of claim 27, wherein if the extracted subject and/or type of the intercepted document does not correspond to an available specialized translating machine, or if no subject and/or type information is in the intercepted document, the intercepted document is switched to a standard translation machine.

29. A system for supplying a translation of at least a document distributed by a content provider to a user terminal by means of a digital data transmission network, the document being structured by at least one tag which is exploitable by a net browser executed on the user terminal, wherein the distributed documents comprise subject information delimited by subject boundary tags, the system comprising:
means for intercepting each distributed document transmitted by the network to a user terminal;
means for extracting the subject information in the intercepted documents using said subject boundary tags;
means for translating the intercepted document taking account of the subject information extracted from the document, and means for inserting the translation obtained in a structured translation document; and
means for transmitting the translation document to the user terminal instead of the intercepted document, said translation document being displayed on the screen of the user terminal by the net browser.

30. The system of claim 29, wherein the subject information inserted into a document distributed by the content provider is associated with type information of the document, delimited in the document by type boundary tags, chosen so as to be not interpreted by the net browser, so that the type information is not displayed when the distributed document is displayed on the screen of the user terminal, said translation means taking account of the type information for translating the intercepted document.

31. A server for supplying a translation of at least a document distributed by a content provider to a user terminal by means of a digital data transmission network, the document being structured by at least one tag which is exploitable by a net browser executed on the user terminal, wherein the distributed document comprises subject information delimited by subject boundary tags, the server comprising:
means for intercepting each distributed document transmitted by the network to the user terminal,
means for transmitting a translation request for the intercepted document, and for receiving in reply a structured translation document resulting from the translation of the intercepted document, and;
means for transmitting the translation document to the user terminal instead of the intercepted document.

32. The server of claim 31, further comprising means for receiving, from a user terminal connected to the network, a parameter indicating if the user wishes or not to obtain a translation document instead of the documents that were sent to him by the network, a translation document being transmitted to the user terminal instead of a document transmitted by the network, as long as the parameter indicates that the user wishes to obtain a translation of the documents transmitted by the network.

33. The server of claim 31, further comprising means for receiving from a user terminal connected to the network, a parameter indicating a target language selected by the user into which the intercepted documents are to be translated.

34. A switching server for switching a structured document to be translated to a specialized translating machine respectively adapted to a subject and/or a type, or to a standard translation machine, comprising:
means for receiving a structured document to be translated comprising subject and/or type information, delimited by subject boundary tags and/or type boundary tags, in association with a document translation request,
means for extracting the subject and/or type information from the intercepted document using said subject and/or type boundary tags;
means for selecting a translating machine adapted to the extracted subject and/or type information, or the standard translation machine if the intercepted document does not comprise subject and/or type information or if the extracted subject and/or type information does not correspond to any of the specialized translation machines, and
means for applying the document to be translated to the selected translating machine.

35. A computer program capable of being executed by a server, for supplying a translation of at least a document distributed by a content provider to a user terminal by means of a digital data transmission network, the document being structured by at least one tag exploitable by a net browser executed by the user terminal, wherein the distributed document comprises subject information delimited by subject boundary tags, the program comprising instructions for:
intercepting each distributed document transmitted by the network to the user terminal,
transmitting a translation request for the intercepted document, and for receiving in reply a structured translation document resulting from the translation of the intercepted document, and
transmitting the translation document to the user terminal instead of the intercepted document.

36. A computer program capable of being implemented on a switching server, for switching a structured document to be translated to a specialized translating machine respectively adapted to a subject and/or a type, or to a standard translation machine, comprising instructions for:
receiving a structured document to be translated comprising subject and/or type information, delimited by subject and/or type boundary tags, in association with a document translation request,
extracting the subject and/or type information from the intercepted document using said subject and/or type boundary tags;
selecting a translation machine adapted to the extracted subject and/or type information, or a standard translation machine if the intercepted document does not comprise subject and/or type information or if the extracted subject and/or type information does not correspond to any of the specialized translation machines, and
apply the document to be translated to the selected translating machine.
